(19) United States
(12) Patent Application Publication
(10) Pub. No.: US 2017/0223054 A1
(43) Pub. Date: Aug. 3, 2017

(54) Methods and Apparatus for Verifying Transport Layer Security Server by Proxy

(71) Applicant: Cisco Technology, Inc., San Jose, CA (US)

(72) Inventors: Daniel Wing, San Jose, CA (US); Jianxin Wang, Saratoga, CA (US); Venkatesh Narsipur Gautam, Sunnyvale, CA (US)

(21) Appl. No.: 15/013,413

(22) Filed: Feb. 2, 2016

(51) Int. Cl. H04L 29/06

(52) U.S. Cl. CPC H04L 63/166; H04L 63/101; H04L 63/061

(57) ABSTRACT

A proxy device intercepts a client transport layer security message including a server name indicator from a client device. The first client transport layer security message is addressed to a server. The proxy device generates a second client transport layer security message including the server name indicator from the first client transport layer security message and sends the second client transport layer security message to the server. The proxy device receives a certificate from the server, validates its identity, and performs policy functions based on that identity.

### TECHNICAL FIELD

This disclosure relates in general to the field of transport layer security, and more particularly, a whitelisting technique for a transport layer security proxy.

### BACKGROUND

Transport layer security (TLS) is a protocol that facilitates private communication between two entities. The two entities may include a client endpoint of an Internet user and a server of an application provider. The TLS protocol prevents any third party devices from eavesdropping on the communication between the two endpoints.

A TLS handshake procedure allows the client endpoint and the application server to exchange cryptographic keys and negotiate an encryption algorithm. The cryptographic keys may be generated for each connection before any of the data of the communication is transmitted. Because of public and private key techniques and public key infrastructure (PKI), the cryptographic keys are secure and unavailable to attackers or eavesdroppers even if they are between the client endpoint and the application server.

A TLS proxy is a security appliance configured to handle the TLS handshake on behalf of the client endpoint or the application server. The security appliance may allow customers to whitelist certain hosts so that communication from the hosts is not intercepted by the security appliance. However, whitelisted addresses may be spoofed.

### BRIEF DESCRIPTION OF THE DRAWINGS

Exemplary embodiments of the present embodiments are described herein with reference to the following drawings.

FIG. 1 illustrates an example of initial messages of a TLS handshake.

FIG. 2 illustrates an example system for performing a TLS handshake.

FIG. 3 illustrates an example flowchart for the system of FIG. 2.

FIG. 4 illustrates an example timing diagram for an intermediate proxy TLS handshake.

FIG. 5 illustrates another example timing diagram for the intermediate proxy TLS handshake.

FIG. 6 illustrates an example flowchart for supervision of TLS handshake.

FIG. 7 illustrates an example network device for the TLS handshake.

FIG. 8 illustrates an example flowchart for the network device of FIG. 7.

### DESCRIPTION OF EXAMPLE EMBODIMENTS

### Overview

In an embodiment, a proxy processor or controller for a proxy device performs intercepting a first client transport layer security message including a server name indicator from a client device. The first client transport layer security message is addressed to a server. The proxy device generates a second client transport layer security message including the server name indicator from the first client transport layer security message and sends the second client transport layer security message to the server with an address associated with a proxy device including the proxy processor or an address of the client device. The proxy device receives a certificate from the server and performs a comparison of the certificate to a policy list for the proxy device.

In another example, an apparatus monitors communications from a client device, identifies a first client transport layer security message from the communications from the client device, wherein the first client transport layer security message includes a server name indicator and is addressed to a server, generates a second client transport layer security message including the server name indicator from the first client transport layer security message, sends the second client transport layer security message to the server, receives a reply message from the server, wherein the reply message includes a certificate from the server, and performs a comparison of an address from the certificate to a list of addresses stored in the memory.

In another embodiment, a non-transitory computer readable medium includes instructions that when executed are configured to cause a processer to analyze, at a proxy device, communications between a client device and a server, identify, at the proxy device, a first client transport layer security message including a requested server name from the client device, wherein first client transport layer security message is addressed to the server, generate, by the proxy device, a second client transport layer security message including the requested server name from the first client transport layer security message, send the second client transport layer security message to the server, receive a certificate with an address of the server, and compare the address from the certificate to a list of addresses.

### Example Embodiments

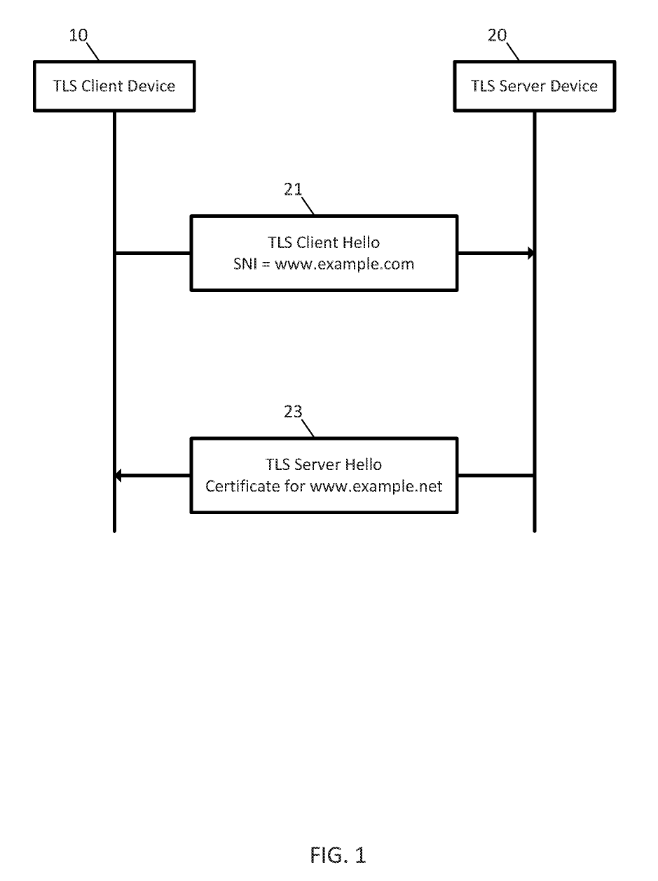

FIG. 1 illustrates an example initial TLS handshake between a TLS client device 10 and a TLS server device 20. The TLS client device 10 is the endpoint initiating the TLS connection. The TLS client device 10 and the TLS server device 20 are configured to perform an initial negotiation for a handshake between the TLS client device 10 and the TLS server device 20 to establish the parameters of the TLS connection and associated transactions. The TLS client device 10 sends a TLS ClientHello message 21 to the TLS server device 20 as part of a hypertext transfer protocol secure (HTTPS) connection. The TLS ClientHello message 21 includes a server name indication (SNI) extension as described in RFC 6066 dated January 2011 and available on the Internet Engineering Task Force (IETF) website. The example SNI extension, which may be described as a requested server address, shown in FIG. 1 is www.example.com. In response, the TLS server 20 sends one or multiple server handshake messages 23 to the TLS client device 10. The service handshake message 23 may include a contribution to the master secret used to derive a session key for this instance of communication between the TLS client device 10 and the TLS server 20. The server handshake message 23 may also include a certificate with an actual server address that corresponds to the requested server. The example shown by FIG. 1 illustrates an address for the actual server of www.example.net. In this example, the actual server and the requested server do not match.

A proxy device or a security appliance may monitor communication between the TLS client device 10 and the TLS server device 20 to identify the mismatch. In some examples, such as using up to TLS version 1.2, as described in RFC 5246 dated August 2008 and available on the IETF website, the security appliance may intercept and analyze communication between the TLS client device 10 and the TLS server device 20. The security appliance may compare the SNI indicative of the requested server to the actual server. The security appliance may also obtain the actual identity of the server device 20 by analyzing the certificate from the server device 20. The comparison is possible because no encryption is used in TLS versions 1.2 and below.

However, in other examples, such as using TLS version 1.3, as described in “draft-ietf-tls-tls13-10” published Oct. 19, 2015 and available on the IETF website, encryption is added to the TLS communications including the handshake. The security appliance does not have access to the encryption keys and therefore, cannot monitor the TLS communications and handshake. The following embodiments overcome this downfall by intercepting the initial handshake messages from the TLS client device at a security appliance and initiating a secondary TLS handshake from the security appliance to the TLS server device. The security appliance may verify that the server domain name in the secondary TLS handshake matches the requested domain name from the initial handshake messages. In other words, the security appliance pauses a TLS handshake received from the TLS client device and initiates a second TLS handshake to verify the identity of the server.

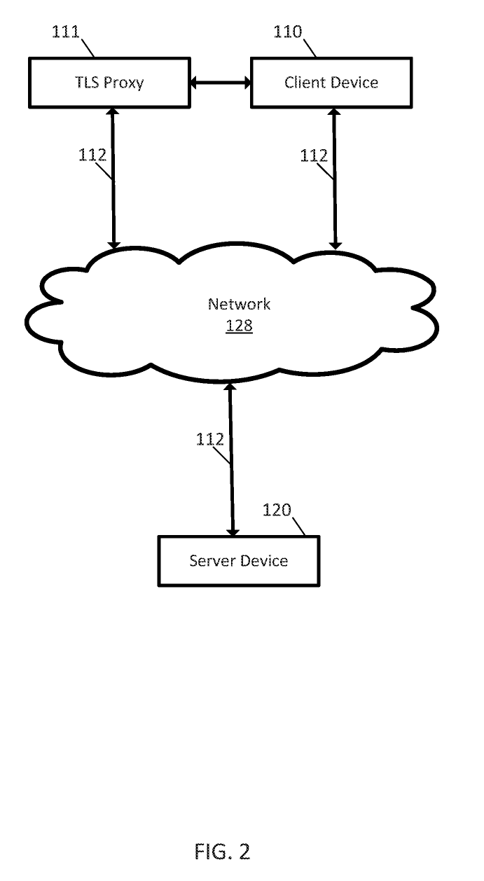

FIG. 2 illustrates an example system for performing a TLS handshake. The system includes a client device 110, a TLS proxy 111, and a server device 120, which communicate via a network 128 and communication paths 112. The TLS proxy 111 may include a proxy processor specialized for performing the following examples. The communication may occur through the transport layer is part of an open system interconnection (OSI) model that defines a networking framework for implementing protocols in seven layers. Control in this model is passed from one layer to the next, starting at the seventh layer and proceeding to the first layer. The layers from the seventh to the first are application, presentation, session, transport, network, data-link, and physical. The fourth layer (L4) is the transport layer. The network 128 may include one or more transmission control protocol/internet protocol (TCP/IP) networks. Additional, different, or fewer components may be included.

The client device 110 may be a smartphone, laptop, a tablet, a desktop computer, and/or another type of device. The client device 110 may be combined with another device such as a customer edge router, a gateway, a firewall or another network administrative device. The client device 110 may send one or more requests for data via web browsers, email applications, instant messaging applications, and/or voice over Internet protocol (VoIP) application. TLS may encrypt data associated with a layer four (L4) transport protocol for use in end-to-end connections across a network. The server device 120 may include a web hosting server, an email server, an instant messaging server, or a VoIP server. TLS may be used to protect web traffic, session initiation protocol, or simple mail transfer protocol. TLS may be used to establish a virtual private network may be used to tunnel traffic between the client device 110 and the server device 120.

The TLS proxy 111, which may be referred to as a security appliance, may monitor the communications between the client device 110 and the server device 120. Some portions of the TLS handshake may be encrypted and other portions of the TLS handshake may be left open to passive observers such as the TLS proxy 111. In one example, the negotiation phase of the TLS handshake is not encrypted. In another example, the initial ClientHello message is not encrypted.

The TLS proxy 111 may include one or more security lists that classify domain names or addresses in order to apply transport layer security. The list may be a single lookup table with one or more designations for the domain names or addresses. The designations may include a whitelist (e.g., positive policy list), a blacklist (e.g., negative policy list), a gray list and/or another designation. A whitelist may include domain names or addresses that have been at least temporarily approved for communication through the TLS proxy 111 as either clients or servers. A blacklist may include domain names or addresses that are prohibited from communication through the TLS proxy 111 as either clients or servers. An administrator of the TLS proxy 111 or the network 128 may set an initial whitelist and/or blacklist. The following examples provide systems and methods through which domain names or addresses are added to or removed from the whitelist and/or blacklist.

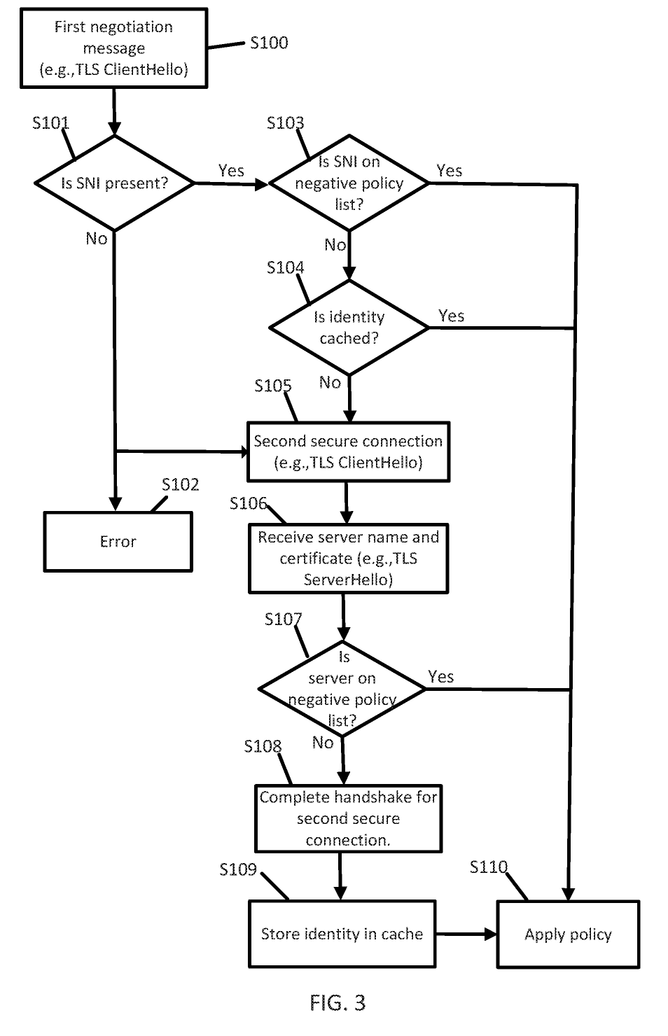

FIG. 3 illustrates an example flowchart for the system of FIG. 2. In S100, a first secure connection (e.g., user datagram protocol or TCP) is initiated by the client device 110. As part of attempting to establish a first secure connection with the server device 120, at least one initial negotiation message is sent from the client device 110 to the server device 120. The TLS proxy 111 intercepts the initial negotiation message. The interception may not be detectable by the client device 110 or the server device 120.

In S101, the TLS proxy 111 determines whether an SNI is present in the initial negotiation message. The TLS proxy 111 may first examine the initial negotiation message. The TLS proxy 111 may parse the initial negotiation message for the SNI field and extract the corresponding value. When no SNI value can be identified or no SNI field is present, in S102, the TLS proxy 111 may generate an error. An error message may be returned to the client device 110 indicating that the initial negotiation of a secure connection was not successful. In one alternative, when no SNI value can be identified or no SNI field is present, the initial negotiation message is forwarded to the server device 120. There is no risk of unauthorized connection when the initial negotiation message is insufficient to result in a secure connection. As discussed below, in one alternative or addition, when no SNI value is identified or no SNI field is present in the initial negotiation message, the process proceeds to S105.

When the SNI is present, the TLS proxy 111 proceeds to S103. In S103, the TLS proxy 111 determines whether the SNI is on a negative policy list. The TLS proxy 111 may access a lookup table in memory with at least a backlist or negative policy list that includes addresses or domain names that are prohibited or otherwise monitored. In other words, a secure connection between the client device 110 and any of the listed addresses or domain names are either not permitted or given further scrutiny under the security policy applied to the client device 110.

When the SNI is on the negative policy list, no further analysis is needed. The TLS proxy 111 may immediately proceed to apply a policy at S110. The policy may block communication between the client device 110 at entries on the negative policy list. The policy may intercept communication and inspect the traffic according to the security policy. The TLS proxy 111 may decrypt the communication from the client device 110, inspect the decrypted data, and re-encrypt the data after inspection.

Returning to S103, when the SNI is not on the negative policy list, the TLS proxy 111 proceeds to S104. In S104, the TLS proxy 111 determines whether the SNI is listed on an identity cache. The identity cache may include addresses or domain names with identities that have been confirmed from earlier instances of the process of FIG. 3. When the SNI is listed on the identity cache, the TLS proxy 111 may immediately proceed to apply a policy at S110. The policy may block communication between the client device 110 at entries on the negative policy list. The policy may intercept communication and inspect the traffic according to the security policy.

When it is determined in S104 that the SNI is not listed on the identity cache, the TLS proxy proceeds to S105. In S105, a second secure connection (e.g., user datagram protocol or TCP) is initiated and established between the TLS proxy 111 and the server device 120. Another set of initial negotiation messages (e.g., ClientHello and ServerHello messages) are exchanged between the TLS proxy 111 and the server device 120. The first secure connection and the second secure connection are independent. The client device 110 is not aware of the second connection. Alternatively, the process may proceed directly from S101 to S105 when no SNI value is identified or no SNI field is present initial negotiation message.

In S106, the TLS proxy 111 receives a server name and certificate from the server device 120. In S107, the TLS proxy 111 determines whether the server name received from the server device 120 is on the negative policy list, which may be the same negative policy list from S103. When the server name is on the negative policy list, then the TLS proxy 111 proceeds to apply policy at S110.

When the server name is not on the negative policy list, then the TLS proxy 111 proceeds to S108. At S108 the TLS proxy 111 completes the handshake with the server device 120 for the second secure connection. At S109, the TLS proxy 111 stores the identity of the server device 120 in a cache. The identity of the server device 120 may be the server name or may be another identifier (e.g., IP address). TLS proxy 111 may proceed to apply a policy at S110.

The policy may block a data flow or other communication associated with the initial negotiation message sent from the client device 110 based on the comparison of the server name with entries on the negative policy list. The policy may intercept communication and inspect the traffic according to the security policy. The policy may block a data flow or other communication associated with the initial negotiation message sent from the client device 110 based on the comparison of the server name with entries on the negative policy list. Conversely, the policy may permit a data flow or other communication associated with the initial negotiation message sent from the client device 110 based on the comparison of the server name with entries on the negative policy list. That is, the data flow may be permitted in the absence of a matching entry on the negative policy list. Alternatively, the policy may permit a data flow or other communication associated with the initial negotiation message sent from the client device 110 based on matching the server name with the positive policy list.

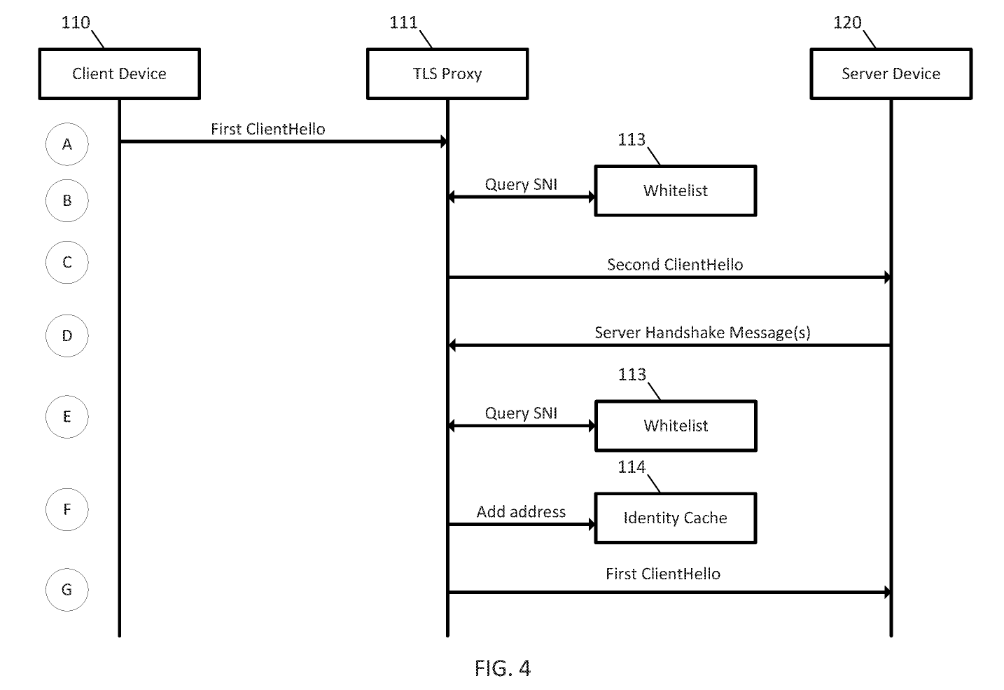

FIG. 4 illustrates an example timing diagram for another embodiment for the TLS handshake communication between that client device 110, the TLS proxy 111, and the server device 120. Additional, different, or fewer entries or stages in the timing diagram may be included.

At stage A, the client device 110 generates a ClientHello message, which may be referred to as an initial message or a first ClientHello message, and sends the ClientHello message to the TLS Proxy 111. The ClientHello message may include a SNI, a protocol version, a random number, a list of compatible suites, and a list of compatible compression algorithms. The SNI is a hostname or name that is assigned to a device connected to a computer network. The protocol version may identify one or more versions of TLS that is supported or requested by the client device.

The random number may be used to generate session keys for the TLS session. The list compatible compression algorithms include one or more compression algorithm for the TLS session. The list of compatible suites may include combinations of authentication, encryption, and key exchange algorithms. The key exchange algorithm may include Diffie-Hellman keys. The key exchange algorithm may not require any prior relationship, negotiation, or handshake between the client device 110 and the server device 120. In one example, the key exchange algorithm does not require a secure channel because of a public and private key pair. The public key may be used to encrypt data that can be decrypted only by a corresponding private key.

In one example, the initial ClientHello message may include a session identifier of an earlier TLS session. The earlier TLS session may have been interrupted due to a technical problem or terminated by a user. The session identifier may be used to reestablish a previously used TLS handshake between the client device 10 and the server device 20.

The SNI address from the ClientHello message is stored locally by the TLS proxy 111. For example, the TLS proxy 111 may include a table in memory for storing data on pending ClientHello messages. In addition, the table may include a cache of SNI addresses or ClientHello messages from past negotiated TLS sessions.

At stage B, the TLS proxy 111 extracts the SNI or requested server address from the initial ClientHello message. The TLS proxy 111 may query a whitelist 113. The whitelist 113 may include a list of pre-approved hostnames. The whitelist 113 may be established by an administrator of the network 128. The whitelist 113 may be created over the time as individual hosts successfully negotiate the TLS handshake with the TLS proxy 111. The TLS proxy 111 may compare the extracted SNI with existing hostnames on the whitelist 113.

In one example, the whitelist 113 serves as a list of acceptable addresses approved for communication with the client device 110 and remains constant. In another example, the whitelist 113 is updated according to the following sequence.

At stage C, the TLS proxy 111 generates another ClientHello message, which may be referred to as an intermediary message or an intermediary (second) ClientHello message, and sends the second ClientHello message to the server device 120. The intermediary ClientHello message is based on the initial ClientHello message. The TLS proxy 111 takes the place of the client device 110 and sends the intermediary ClientHello message to the host that is included in the SNI of the initial ClientHello message. In one sense, the TLS proxy 111 duplicates the first ClientHello message and inserts the address of the TLS proxy 111 into the duplicated ClientHello message. In one example, the duplicated ClientHello message also includes the address of the client device 10.

At stage D, the server device 120 generates a ServerHello message, which may be referred to as a response message, in response to the second ClientHello message. The server device 120 may not be aware of the client device 110 or the initial ClientHello message. In other words, the TLS handshake corresponding to the second ClientHello message is between the server device 120 and the TLS proxy 111. The handshake may be encrypted according to an encryption technique decided by the TLS proxy 111 and the server device 120. The encryption technique may be independent from any policies or settings of the client device 110. Thus, the second handshake is a full handshake independent of the client device 110.

The TLS proxy 111 may extract a certificate from the ServerHello message. The certificate may include a named subject or address and proves the ownership of a public key by the named subject. In some examples, the certificate is included in a separate certificate message. The specifics of the transmission of the certificate may be specified by a version of the cipher suite.

At stage E, the TLS proxy 111 compares an address of certificate to a previously stored address of the whitelist 113 or to the SNI of the initial ClientHello message. The comparison may determine whether the certificate and the previously stored address are a complete match, or to what degree the previously stored address and the certificate match. For example, the previously stored address and the certificate may include an address (e.g., hostname under the domain name system) made of multiple levels separated by periods. The multiple levels may include a first level as a hostname or leaf domain, a second level for a primary name or second-level domain, and a third level for a top-level domain (e.g., com, gov, net, and org).

In one example, the address from the previously stored address is resolved into a first Internet protocol (IP) address and the address from the certificate into a second IP address, and the first and second IP addresses are compared. The comparison may include a first comparison of one of the levels of the address and a second comparison of another of the levels in the address.

At stage F, the TLS proxy 111 may modify an identity cache 114 based on the comparison. When the comparison indicates that the previously stored address matches the address of the certificate, the address is added to the identity cache 114 and stored in memory of the TLS proxy 111. The TLS proxy 111 may distribute the identity cache 114 to other devices (e.g., other proxy devices) on the network 128.

In some examples, the degree of match that causes the identity cache 114 to be modified may be less than an exact match. For example, when a predetermined number of the levels in the hostnames are the same, the addresses are considered a match. The predetermined number may be two or three. In another example, the predetermined number may be N−1, in which N is the total number of levels in the hostname.

The TLS proxy 111 may define a security policy according to the comparison of the address from the SNI in the initial ClientHello message and the address associated with the certificate of the ServerHello message. When the addresses match, the TLS proxy 111 may pass communications between the client device 110 and the server device 120 without inspection. When the addresses do not match, the TLS proxy 111 may inspect communications between the client device 110 and the server device 120. The inspection may be a test for malicious software (e.g., virus, worm, malware, or other specific types of programs). The inspection may be a test for certain types of content. For example, the network 128 may have a policy against games or adult content. The TLS proxy 111 may maintain different security policies for different clients. That is, one client may have access to different types of content than another client.

The security policy may be selected from multiple security levels according to the comparison. When the comparison indicates a majority match between the client device 110 and the server device 120, the TLS proxy 111 may enforce a first policy level (e.g., malicious software scan). When the comparison indicates low match between the client device 110 and the server device 120, the TLS proxy 111 may enforce a second policy level (e.g., deep packet inspection). When the comparison indicates no match between the client device 110 and the server device 120, the TLS proxy 111 may enforce a third policy level (e.g., blocking the communication). In one alternative, the TLS proxy 111 sends the security policy to a security enforcement device (e.g., security as a service server).

As an alternative or modification of stage F, the proxy device 111 may generate an alert message in response to the SNI in the initial ClientHello message and the address associated with the certificate of the ServerHello message being a mismatch or not matching. The alert message may be send to an administrator of the network 128 or to the client device 110. The alert message may indicate that a security warning has been detected or suspicious activity has been detected. The alert message may indicate the degree of mismatch between the SNI and the address from the certificate. The alert message may include the SNI and the address from the certificate. The alert message may notify a user that the connection has been blocked. It should be noted that a mismatch between the SNI and the address from the certificate may be more relevant to the user of the client device 110 than the TLS proxy 111.

At stage G, the TLS proxy 111 may access the stored the initial ClientHello message that originated with the client device 110 and forward the initial ClientHello message to the server device 120. The TLS handshake between the client device 110 and the server 120 may proceed under the TLS protocol. In other words, direct communication may be exchanged between the client device 110 and the server 120 in one or both direction under the TLS protocol. The communication may be private under the cryptographic or encryption technique specified by the initial ClientHello message and/or ServerHello message.

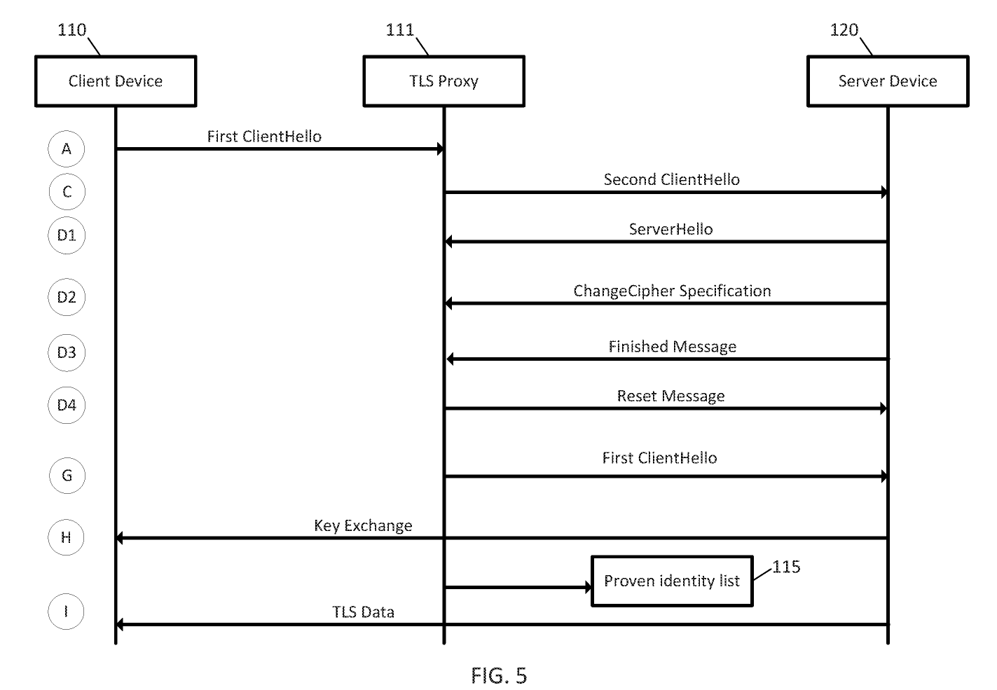

FIG. 5 illustrates another example timing diagram for the TLS handshake communication between that client device 110, the TLS proxy 111, and the server device 120. Additional, different, or fewer entries or stages in the timing diagram may be included. FIG. 5 illustrates additional stages that may be combined with the timing diagram of FIG. 4. However, FIG. 5 illustrates an example sequence that may omit some of the states of FIG. 4. The description of stages A and C is provide above and not repeated in the interest of brevity.

The TLS proxy 111 may access a public key for the server device 120 from a public key authority device. The TLS proxy 111 may encrypt the second ClientHello message using the public key for the server device 120. The TLS proxy 111 may perform a security policy in response to a comparison of the certificate address to a ternary list (e.g., combined negative policy list, positive policy list, and a confirmed identity list) and a completion of the TLS handshake with the TLS proxy 111. Completion of the TLS handshake may be indicated in a number of ways.

At shown in stages D1-D3, the server device 120 responds to the second ClientHello message by sending multiple TLS messages to the TLS proxy 111. At stage D1, the ServerHello message, or response message may include a certificate with a named subject, address, or other data that demonstrates the ownership of a public key by the named subject.

At stage D2, the server device 120 sends a ChangeCipher specification message to the proxy device 111 in response to the second ClientHello message. The ChangeCipher specification message indicates that subsequent communications are encrypted and the protected under the TLS negotiation. The ChangeCipher specification message may be sent in response to compatibility of the encryption techniques between the proxy device 111 and the server device 120. The ChangeCipher specification message is sent during the handshake process, before the handshake process is finished, but after security parameters have been agreed upon.

At stage D3, the server device 120 sends a finished message to the proxy device 111 in response to the second ClientHello message. The finished message may be generated by the server device 120 in response to the completion of the handshake process and sent to the proxy device 111. The finished message verifies that the key exchange and authentication process between the server device 120 and the proxy device 111 was successful. The proxy device 111 may generate and send a verification message to the server device 120 in response to the finished message. The finished message and the ChangeCipher message may be referred to in the alternative as a completion message.

In one example the finished message includes a hash of the second ClientHello message received from the proxy device 111. The proxy device 111 and the server device 120 are configured to perform the same hash function on the second ClientHello. In response to receiving the finished message, the proxy device 111 compares the received hash result from the sever device 120 to an expected value calculated by the proxy device 111. When the received value is equal to the expected value, the proxy device 111 verifies the identity of the server.

At stage D4, the proxy device 111 sends a reset message to the server device 120. The reset message closes the TLS connection between the proxy device 111 and the server device 120. The reset message may be an HTTP reset or TCP reset command. The TCP reset command may be a packet that includes a control header with a bit or a reset flag. In a majority of TLS packets, the reset flag is set to zero, but in the TCP reset command, the reset flag is set to 1 to indicate that the server device 120 should immediately stop using the TCP connection. In one example, the connection is aborted by sending an optional TLS Abort and then sending a TCP RST packet or TCP FIN sequence of packets. Stage D4 may be before stage D3 or D2.

In this way, the proxy device 111 determines that the server device 120 corresponds to the SNI in the initial ClientHello message from the client device 110 and permits communication between the client device 110 and the server device 120.

At stage H, the client device 110 and the server device 120 exchange keys and other messages to complete the TLS handshake. The messages may include ServerKeyExhange and ServerHelloDone.

The TLS proxy 111 may add the address of the server device 120 to a proven identity list 115 that is stored in memory and/or distributed to other devices on the network 128. When subsequent traffic is received, the TLS proxy 111 queries the proven identity list 115 to determine that the server device 120 has already completed a TLS handshake with the TLS proxy 111. In some examples, the proven identity list 115 is reset in response to an event or passage of time.

For example, the TLS proxy 111 may periodically clear or delete the entries on the proven identity list 115 according to a predetermined schedule. The predetermined schedule may include a reset of the proven identity list 115 every time period (e.g., a few minutes to a few hours, or every 24 hours). The predetermined schedule may be set according to an administrator of the network 128. Alternatively, each entry in the proven identity list 115 may be associated with an expiration date or a time period, and individual entries are removed upon expiration. Thus, the TLS proxy 111 permits data flow to be transmitted between the client device 110 to the server device 120 for a time period after the identity of the server device 120 has been proven through the TLS handshake process.

In another example, the event for clearing the proven identity list 115 may be a security event. For example, when a worm, a virus, or other malicious software is detected from any source, the TLS proxy 111 may clear the entire proven identity list 115. In another example, the event for clearing the proven identity list 115 may be a power event. For example, when the TLS proxy 111 is rebooted or an interruption in power occurs for another reason (e.g., crash), the TLS proxy 111 may clear the entire proven identity list 115.

When the proven identity list 115, all subsequent communications from the client device 110 or other client devices are examined and identity of the server device 120 is reestablished using the procedures described in FIGS. 4 and 5. Thus, when the proven identity list 115 is cleared and the client device 110 sends subsequent communications, the TLS proxy 111 is configured to generate a third client transport layer security message including the server name indicator from the first client transport layer security message.

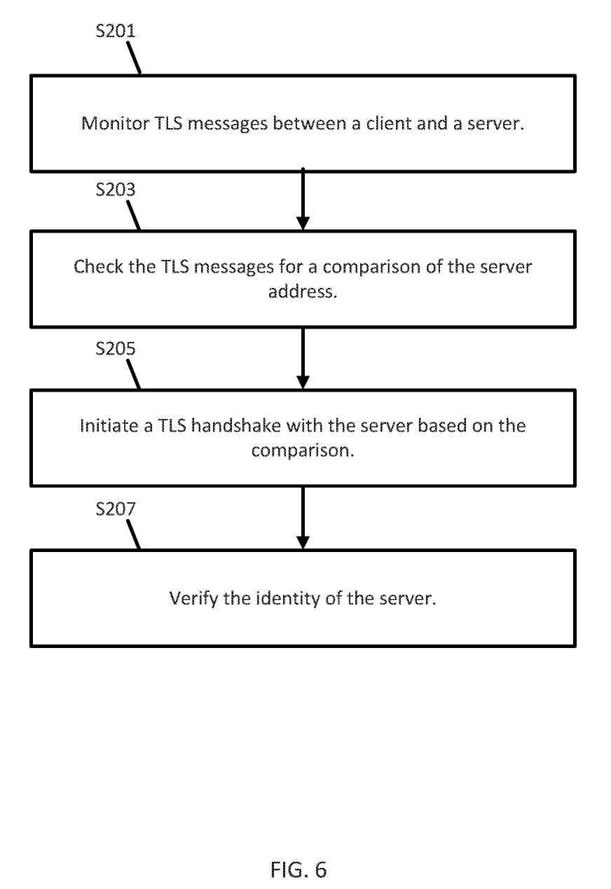

In one alternative, rather than perform the verification of servers at the TLS proxy 111, the client devices (e.g., client device 110) performs the verification and the TLS proxy 111 supervises the process and steps in when an anomaly is detected or suspected. FIG. 6 illustrates an example flowchart for supervision of the TLS procedure. Additional, different, or fewer acts may be included.

At act S201, the TLS proxy 111 monitors the TLS messages between the client device 110 and the server device 120. The TLS proxy 111 may not intercept the initial ClientHello message as described above, but instead the client device 110 is tasked with verifying the identity of the server device 120. The TLS proxy 111 monitors the message between the client device 110 and the server device 120 to make sure the client device 110 is properly carrying out the procedure.

In one example, the TLS proxy 111 samples TLS messages according to a time period or a predetermined number of messages. For example, as a time period (e.g., 10 minutes, one hour, one day or another value) elapses, the TLS proxy 111 identifies a sequence of ClientHello and ServerHello messages.

At act S203, the TLS proxy 111 checks the TLS messages for a comparison of the requested server address and the certificate received from the server device 120, and a comparison of the received certificate and a policy list such as a positive policy list or a negative policy list. The TLS proxy 111 examines the sequence of ClientHello and ServerHello messages from a first handshake. The TLS proxy 111 extracts the SNI including the requested address from the ClientHello message and extracts the actual address of the server device from the certificate in the ServerHello message.

When the comparison shows that the address in the received certificate and the compared address are the same or similar within a degree of similarity, the TLS proxy 111 does nothing further and the communications between the client device 110 and the server device 120 are not interrupted. However, when the comparison shows that the requested address and the actual address are not the same or within the degree of similarity, the 111 initiates a TLS handshake (second handshake) with the server device 120, as shown by act S205. The TLS Proxy 111 inserts the requested address from the first handshake into the ClientHello message of the second handshake. The degree of similarity may be a predetermined number of characters or percentage of characters in the hostname or the IP address.

At act S207, the TLS proxy 111 verifies the identity of the server device 120. For example, server device 120 sends the TLS proxy 111 a certificate including the address of the server device 120. The TLS proxy 111 compares the actual address to the requested address. When the two match either exactly or within a degree of similarity, the TLS proxy 111 determines that the server device 120 is verified and may be added to a table of approved devices (e.g., whitelist 113 or proven identity list 115).

When the addresses do not match, the TLS proxy 111 make take one or more remedial measures. In one example, the server device 120 is blacklisted and all communications with the server device 120 are blocked. In another example, communications to and from the server device 120 are subjected to increased scrutiny. The data may be decrypted and examined by the TLS proxy 111. The data may be scanned for malicious software or unauthorized or illegal content. In another example, the TLS proxy 111 may generate an alert to an administrator or to the client device 110 that indicates that suspicious activity has been detected.

In another example, the client device 110 may be flagged and all communications from the client device 110 are monitored. A user of the client device 110 may be intentionally skipping the verification process in order to circumvent a firewall or another security device.

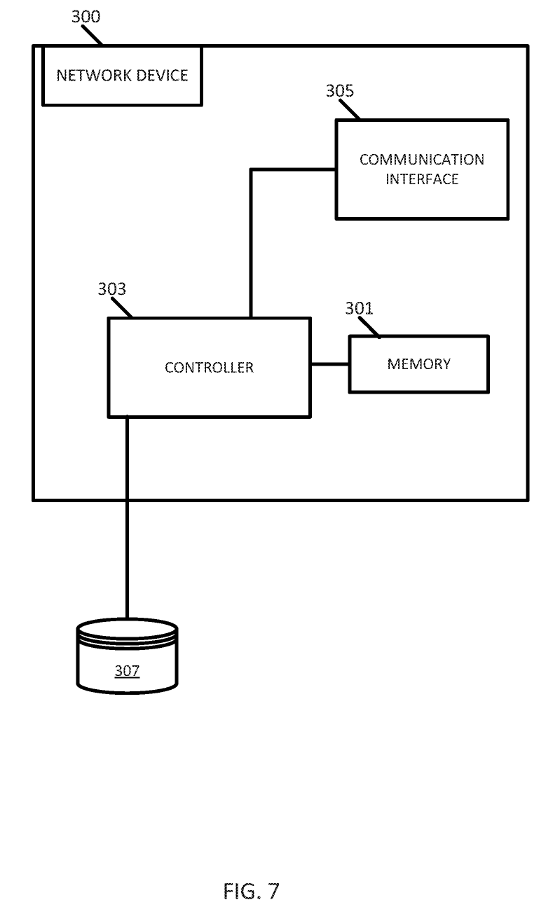

FIG. 7 illustrates an example computing network device 300 for the TLS handshake. The computing network device 300 may correspond to the TLS proxy 111 or the client server 110. The computing network device includes at least a memory 301, a controller 303, and a communication interface 305. The controller 303 may correspond to a proxy processor. Additional, different, or fewer components may be provided. Different network devices may have the same or different arrangement of components.

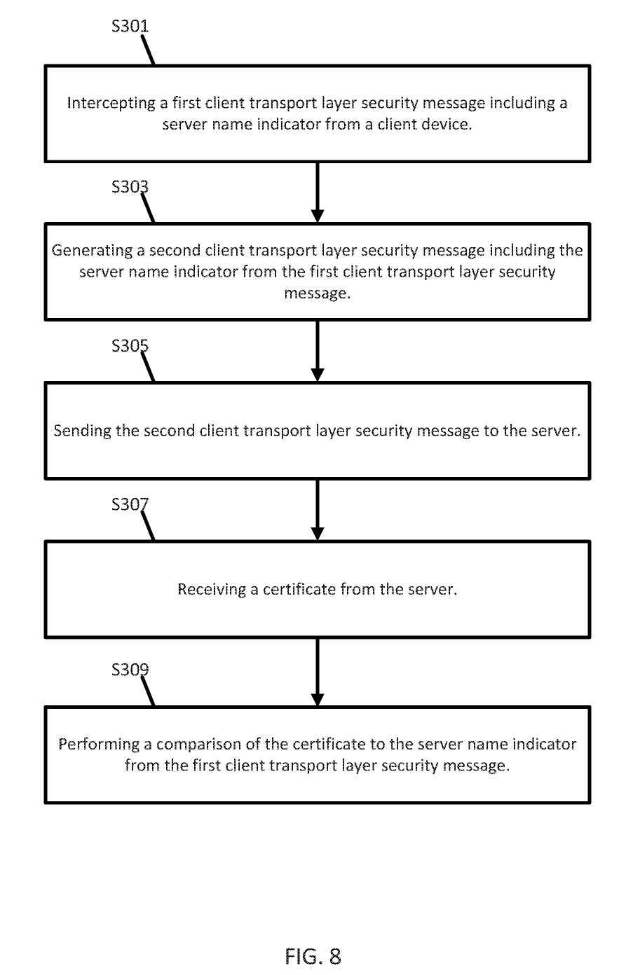

At act S301 of FIG. 8, the controller 303 or the communication interface 305 intercepts a first client transport layer security message including a server name indicator sent by a client. The client transport layer security message may be a control message or initialization message for TLS. The first client transport layer security message may be associated with a media stream such as an online meeting, a video, a voice call, or an audio stream. The first client transport layer security message is addressed to a server that purportedly corresponds to the server name indicator sent. The first client transport layer security message may be temporarily stored in memory 301.

At act S303, the controller 303 generates a second client transport layer security message including the server name indicator from the first client transport layer security message. The second client transport layer security message is also a control message or initialization message for TLS. The second client transport layer security message is configured to establish a TLS connection between the example computing network device 300 and the server. At act S305, the controller 303 or the communication interface 305 sends the second client transport layer security message to the server.

At act S307, the controller 303 or the communication interface 305 receives a certificate from the server. At act S309, the controller 303 or the communication interface 305 performs a comparison of the certificate to at least one security list or the server name indicator from the first client transport layer security message. When the certificate matches the server name indicator, then the identity of the server has been verified. When the certificate does not match the server name indicator, the controller 303 may generate an alert message that indicates suspicious activity has been detected. When the certificate does not match the server name indicator, the controller 303 may filter or block traffic. The filtered or blocked traffic could be the packets associated with the first client transport layer security message. The filtered or blocked traffic could be all traffic associated with the server or all traffic from the sender of the first client transport layer security message.

In addition, the controller 303 or the communication interface 305 may receive a completion message for a handshake negotiation including the second transport layer security message. The completion message may include a hash of the second client transport layer security message.

Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The controller 303 may include a general processor, digital signal processor, an application specific integrated circuit (ASIC), field programmable gate array (FPGA), analog circuit, digital circuit, combinations thereof, or other now known or later developed processor. The controller 303 may be a single device or combinations of devices, such as associated with a network, distributed processing, or cloud computing.

The memory 301 may be a volatile memory or a non-volatile memory. The memory 301 may include one or more of a read only memory (ROM), random access memory (RAM), a flash memory, an electronic erasable program read only memory (EEPROM), or other type of memory. The memory 301 may be removable from the network device 103, such as a secure digital (SD) memory card.

In addition to ingress ports and egress ports, the communication interface may include any operable connection. An operable connection may be one in which signals, physical communications, and/or logical communications may be sent and/or received. An operable connection may include a physical interface, an electrical interface, and/or a data interface.

The memory 301 are non-transitory computer-readable media, which may be a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer readable medium may be non-transitory, which includes all tangible computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

We claim:

1. A method comprising:
intercepting, at a proxy processor, a first client transport layer security message including a server name indicator from a client device, wherein the first client transport layer security message is addressed to a server;
generating, by the proxy processor, a second client transport layer security message including the server name indicator from the first client transport layer security message;
sending the second client transport layer security message to the server with an address associated with a proxy device including the proxy processor or an address of the client device;
receiving a certificate from the server; and
performing a comparison of the certificate to a policy list for the proxy device.

2. The method of claim 1, wherein the first client transport layer security message is intercepted from a first connection, the method further comprising:
generating a second connection for the second client transport layer security message.

3. The method of claim 1, further comprising:
receiving a completion message for a handshake negotiation including the second transport layer security message; and
storing an identity from the certificate in an identity cache in response to the completion message for the handshake negotiation.

4. The method of claim 1, further comprising:
generating an alert message in response to at least the comparison of the certificate to the policy list.

5. The method of claim 1, further comprising:
blocking a data flow associated with the first client transport layer security message in response to at least the comparison of the certificate to the policy list.

6. The method of claim 1, further comprising:
performing an inspection of a data flow associated with the first client transport layer security message in response to at least the comparison of the certificate to the policy list.

7. The method of claim 1, further comprising:
permitting, by the proxy processor, a data flow to be transmitted to the server from the client device in response to at least the comparison of the certificate to the policy list.

8. The method of claim 7, further comprising:
generating, in response to the time period elapsing, a third client transport layer security message including the server name indicator from the first client transport layer security message.

9. The method of claim 1, further comprising:
receiving a finished message from the server, wherein the finished message includes a hash of at least the second client transport layer security message and the certificate; and
verifying an identity of the server when the hash is an expected value.

10. The method of claim 1, further comprising:
selecting a security policy based on the comparison.

11. An apparatus comprising:
a processor; and
a memory comprising one or more instructions executable by the processor to perform:
monitoring communications from a client device;
identifying a first client transport layer security message from the communications from the client device, wherein the first client transport layer security message includes a server name indicator and is addressed to a server;
generating a second client transport layer security message including the server name indicator from the first client transport layer security message;
sending the second client transport layer security message to the server;
receiving a reply message from the server, wherein the reply message includes a certificate from the server; and
performing a comparison of an address from the certificate to a list of addresses stored in the memory.

12. The apparatus of claim 11, the instructions executable by the processor to perform:
applying a security policy based on the comparison.

13. The apparatus of claim 11, the instructions executable by the processor to perform:
receiving an indication that a handshake negotiation including the second transport layer security message is successful.

14. The apparatus of claim 11, wherein the comparison of the address from the certificate to the list of address stored in memory is a second comparison, the method further comprising:
performing a first comparison of the server name indicator to the list of address stored in memory.

15. The apparatus of claim 13, the instructions executable by the processor to perform:
applying a security policy based on the first comparison and the second comparison.

16. The apparatus of claim 11, the instructions executable by the processor to perform:
filtering the communications from the client device based on the comparison of the address from the certificate list of addresses stored in the memory.

17. A non-transitory computer readable medium including instructions that when executed are configured to cause a processer to:
analyze, at a proxy device, communications between a client device and a server;
identify, at the proxy device, a first client transport layer security message including a requested server name from the client device, wherein first client transport layer security message is addressed to the server;
generate, by the proxy device, a second client transport layer security message including the requested server name from the first client transport layer security message;
send the second client transport layer security message to the server;
receive a certificate with an address of the server; and
compare the address from the certificate to a list of addresses.

18. The non-transitory computer readable medium of claim 17, wherein the instructions that when executed are configured to cause a processer to:
block communications between the client device and the server when the address from the certificate is designated as prohibited on the list of addresses.

19. The non-transitory computer readable medium of claim 17, wherein the instructions that when executed are configured to cause a processer to:
allow communications between the client device and the server when the address from the certificate is designated as whitelisted on the list of address.

20. The non-transitory computer readable medium of claim 17, wherein the instructions that when executed are configured to cause a processer to:
inspect communications between the client device and the server in absence of a designation on the list of address for the address from the certificate.
